(19) United States
(12) Patent Application Publication
(10) Pub. No.: US 2026/0015459 A1
(43) Pub. Date: Jan. 15, 2026

(54) Method for synthesizing polyphenylene ether

(71) Applicant: Chem Tech Solutions, LLC, Katy, TX (US)

(72) Inventor: Srinivas Yerraparagada, Katy, TX (US)

(73) Assignee: Chem Tech Solutions, LLC, Katy, TX (US)

(21) Appl. No.: 18/773,554

(22) Filed: Jul. 15, 2024

(51) Int. Cl. C08G 65/40; C08G 65/46

(52) U.S. Cl. CPC C08G 65/4093; C08G 65/4087; C08G 65/46; C08G 2650/62

(57) ABSTRACT

A method for synthesizing polyphenylene ether. The method involves conducting a condensation reaction of polymer monomers and oxygen under the action of a catalyst to form polyphenylene ether. By controlling the addition rate and amount of the catalyst during the reaction process, the molecular weight and molecular weight distribution of the polyphenylene ether can be regulated. Using the synthesis method of the present invention, the molecular weight and molecular weight distribution of the polyphenylene ether product can be effectively controlled by managing the addition rate and amount of the catalyst.

### FIELD OF THE INVENTION

The present invention relates to the technical field of chemical production, in particular to a method for synthesizing polyphenylene ether.

### BACKGROUND OF THE INVENTION

Polyphenylene Ether is an important engineering plastic with excellent heat resistance, chemical resistance, and electrical insulation properties, and is widely used for preparing high-performance plastic products in electronics, automotive, aerospace, and other fields. Its synthetic process usually involves oxidative polymerization. Specifically, compounds like phenol and oxygen (or air) undergo a condensation reaction under certain temperature and pressure conditions with the aid of a catalyst, gradually forming long-chain polymers of polyphenylene ether. This polymerization reaction usually requires a certain reaction time to ensure adequate polymerization.

After filtration, polyphenylene ether in granular form can be obtained. Granular polyphenylene ether then can be further processed into plastic products, for example, by extrusion, injection molding, and the like, resulting in the final product. Overall, the synthesis process of polyphenylene ether is a complex oxidative polymerization process that requires strict control of factors such as temperature, pressure, catalyst, and raw material quality.

Currently, there are two main systems for the synthesis of polyphenylene ethers in the prior art, i.e., the solution method and the precipitation method. The synthesis principles and the types of reaction materials for these two methods are essentially the same. The materials used mainly include phenolic compounds (i.e., polymerization monomers), oxygen, catalysts, good solvents, and poor solvents. Polyphenylene ether obtained by the solution method has a wider molecular weight distribution (greater than 2.0) and a lower residual copper content (less than 1 ppm). In contrast, polyphenylene ether obtained by the precipitation method has a narrower molecular weight distribution (less than 1.8), providing better mechanical properties, but with a higher residual copper content (greater than 1 ppm).

In the preparation process of high-molecular-weight polyphenylene ether, a large amount of copper catalyst is inevitably introduced, and the residual copper catalyst can affect the properties of polyphenylene ether in various aspects, including thermal stability, electrical properties, oxidation resistance, processability, and color stability. Therefore, during production and application, it is necessary to strictly control the total amount the copper catalyst used and residual content thereof to ensure that the performance of polyphenylene ether materials meets design requirements and maintains sufficient stability and durability in specific application environments. The synthesis method described in the present invention is suitable for the large-scale production of high molecular weight polyphenylene ether, achieving high-molecular-weight polyphenylene ether while optimizing process parameters to ensure that the residual copper in the final product meets standards.

### SUMMARY OF THE INVENTION

The present invention provides a method for synthesizing polyphenylene ether, which can regulate the molecular weight and molecular weight distribution of polyphenylene ether by controlling the rate and amount of the catalyst, as well as regulate the residual content of copper that is introduced in large amounts in the process of preparing the high molecular weight polyphenylene ether.

The technical solution of the present invention is as follows.

The present invention provides a method for synthesizing polyphenylene ether, wherein a condensation reaction of a polymer monomer and oxygen is conducted under the action of a catalyst to form polyphenylene ether; wherein the molecular weight and molecular weight distribution of polyphenylene ether are regulated by controlling an addition rate and an amount of the catalyst during the reaction process.

In an embodiment, the condensation reaction is carried out in a polymerizer.

In an embodiment, nitrogen is purged to the reactor before the reaction to make an oxygen content less than 2%.

In an embodiment, the polymer monomer is a phenolic compound.

Preferably, the polymer monomer is selected from 2,6-dimethylphenol, 2,6-diethylphenol, 2-ethyl-6-n-propylphenol, 2-ethyl-6-bromophenol, and 2-methyl-6-n-butylphenol.

In an embodiment, the condensation reaction further employs a good solvent and a poor solvent.

The poor solvent is selected from alcohols (such as methanol, ethanol, propanol, butanol, benzyl alcohol, cyclohexanol), ketones (such as acetone, methyl ethyl ketone), esters (such as ethyl acetate, ethyl formate), and ethers (such as tetrahydrofuran, ether, diethyl ether). Preferably, the poor solvent is methanol.

The good solvent is selected from aromatic hydrocarbons (such as benzene, toluene, ethylbenzene, xylene) and halogenated hydrocarbons (such as chloroform, dichloroethane, trichloroethane, chlorobenzene). Preferably, the good solvent is toluene. The mass ratio of the poor solvent to the good solvent is (1˜1.5):1.

In an embodiment, the condensation reaction is carried out under stirring and external circulation conditions. The stirring described in the present invention is conducive to narrowing the molecular weight distribution. The external circulation described in the present invention can remove reaction heat and enhance stirring.

In an embodiment, the catalyst is one or more of cuprous compounds (such as cuprous chloride, cuprous bromide, cuprous nitrate, cuprous sulfate), copper compounds (such as copper chloride, copper bromide, copper nitrate, copper sulfate), and copper salts (such as those obtained by reacting copper oxide or cuprous oxide with hydrohalic acid).

In an embodiment, the condensation reaction also employs a copper ion protector.

The copper ion protector is one or more of secondary alkylene diamines, tertiary amines, and monoamines.

In an embodiment, the method comprises forming a solution containing the catalyst and the copper ion protector.

In an embodiment, the method comprises forming a solution containing the good solvent and the polymer monomer.

In an embodiment, the method comprises adding the solution containing the catalyst and the copper ion protector and the solution containing the good solvent and the polymer monomer to a reaction medium containing the good solvent and the poor solvent

In an embodiment, the polymer monomer is added dropwise to the reaction system, with a total dropwise addition time of 4˜8 min per kilogram of the polymer monomer. Preferably, the total dropwise addition time is 5˜7 min.

In an embodiment, oxygen is introduced to the bottom of the reactor while the polymer monomer is added dropwise, and nitrogen is introduced to the top of the reactor to keep the oxygen concentration in the reaction system below 20%.

Preferably, the oxygen concentration in the reaction system is less than 10%.

In an embodiment, the ratio of the oxygen introduction rate to the nitrogen introduction rate is 1:(5˜20), preferably 1:10. In an embodiment, per unit of time, the molar ratio of introduced oxygen to that of added polymer monomer is 0.5˜1.5, preferably 0.8˜1.0.

In an embodiment, while introducing oxygen, nitrogen is continuously introduced to the top of the polymerizer to keep the oxygen concentration in the gas phase space within the polymerizer below 20%.

Preferably, nitrogen is continuously introduced to the top of the polymerizer to keep the oxygen concentration in the gas phase space within the polymerizer below 10%.

In an embodiment, the method comprises adding the catalyst at a rate that is slow at first and then fast. The method in the present invention avoids a high catalyst concentration and the generation of a large amount of oligomers in the system during the initial reaction stage. This is conducive to increasing the molecular weight while reducing the molecular weight distribution.

In an embodiment, the total addition time of the catalyst is 0.5˜1.0 times the addition time of the polymer monomer.

In an embodiment, starting from the time when oxygen is introduced, the duration of the condensation reaction is 60˜90 min.

In an embodiment, the pressure of the condensation reaction is normal pressure.

In an embodiment, the temperature of the condensation reaction is 20˜50° C.

Preferably, the temperature is maintained at 20˜25° C. during the addition of the polymer monomer.

Preferably, after the addition of the polymer monomer is completed, the temperature is gradually raised to 30˜50° C. and maintained at 30˜50° C. until the end of the reaction. In the present invention, the reaction temperature is gradually increased as the reaction progresses. At the initial stage of the reaction, due to the high homogeneity of the system, a lower reaction temperature helps to avoid the rapid formation of oligomers. As the solid content of the reaction increases and mass transfer resistance grows, it is necessary to gradually raise the temperature to maintain reaction activity. This ensures consistent reaction activity, promoting uniform molecular chain growth and reducing the molecular weight distribution.

In an embodiment, for 1 mol of the polymer monomer, the copper ion content in the reaction system is 0.001˜0.3 mol.

In an embodiment, for 1 mol of the copper ion, the amount of copper ion protector in the reaction system is 0.01˜60 mol.

In an embodiment, the method comprises obtaining a suspension containing polyphenylene ether particles after the condensation reaction; and performing a first copper removal treatment on the suspension, wherein the first copper removal treatment comprises contacting the amino carboxylic acid derivative aqueous solution with the suspension to remove copper through complexation.

In an embodiment, the amino carboxylic acid derivative is one or more of ethylenediaminetetraacetic acid or a salt thereof, iminodiacetic acid or a salt thereof, ethylenediaminetetrapropionic acid or a salt thereof, and nitrilotriacetic acid or a salt thereof; preferably, the amino carboxylic acid derivative is ethylenediaminetetraacetic acid and its di-, tri-, and tetra-sodium or potassium salts.

In an embodiment, a molar ratio of the amount of the amino carboxylic acid derivative to the copper ions is (1˜3):1, preferably 1:1.

In an embodiment, the temperature of the first copper removal treatment is 45˜50° C.

In an embodiment, the time of the first copper removal treatment is 0.2˜1 h.

In an embodiment, the method further comprises performing the solid-liquid separation on the system obtained after the first copper removal treatment, to obtain the polyphenylene ether filter cake and liquid phase components.

In an embodiment, the content of the copper ions in the polyphenylene ether filter cake is 10˜100 ppm.

In an embodiment, the method also comprises performing the second copper removal treatment on the homogeneous solution of the polyphenylene ether filter cake using the aqueous solution of the complexing agent.

In an embodiment, the complexing agent is one or more of sodium gluconate, ethylenediaminetetraacetic acid or a salt thereof, iminodiacetic acid or a salt thereof, ethylenediaminetetrapropionic acid or a salt thereof, and nitrilotriacetic acid or a salt thereof, preferably sodium gluconate. To achieve lower copper residue in the product, the present invention introduces a second copper removal treatment, utilizing the sodium gluconate aqueous solution with strong complexing capabilities.

In an embodiment, the pH of the aqueous solution of the complexing agent is at least 5.

In an embodiment, the homogeneous solution of the polyphenylene ether filter cake is formed by dissolving the first polyphenylene ether filter cake in the good solvent.

In an embodiment, the method also comprises performing the oil-water phase separation after the second copper removal treatment to obtain the homogeneous solution of polyphenylene ether.

In an embodiment, the method further comprises stirring at a temperature of 40˜50° C. for 15˜30 min before the oil-water phase separation.

In an embodiment, a solid polyphenylene ether is obtained after post-treatment.

The post-treatment comprises one or more of precipitation, filtration, washing, and drying.

The present invention provides a polyphenylene ether with a Mn of 30,000˜60,000, a molecular weight distribution of less than 1.8, and a copper residue of less than 0.05 ppm.

According to the description above, the present invention has the following beneficial effects:

The method of the present invention can remove and regulate the residual content of copper, which is introduced in large amounts during the preparation of high molecular weight polyphenylene ether; this is achieved by optimizing the process parameters, so as to regulate the amount of copper residue in the final product, ensuring that the final product meets the use standard.

### BRIEF DESCRIPTION OF DRAWINGS

FIG. 1 shows a schematic diagram of a process route for synthesizing polyphenylene ether in the present invention.

### DETAILED DESCRIPTION OF THE INVENTION

Embodiments of the present invention are described below by specific examples, and other advantages and efficacies of the present invention can be readily appreciated by those skilled in the art from what is disclosed in this specification. The present invention may also be implemented or applied in other different embodiments, and various details in the specification may also be modified or changed based on different views and applications without departing from the spirit of the present invention.

It should be understood that the one or more method steps referred to in the present invention do not exclude that other method steps may exist before or after the aforementioned method steps or that other method steps may be inserted between these expressly mentioned method steps. Unless otherwise stated, it should also be understood that the combination and connection relationships between one or more devices/apparatuses mentioned in the present invention do not exclude the possibility of having other devices/apparatuses before or after the combined devices/apparatuses, or the insertion of other devices/apparatuses between the explicitly mentioned two devices/apparatuses. Unless otherwise specified, the numbering of the method steps is solely for the convenience of identifying each method step and does not restrict the order of the steps or limit the scope of implementation of the present invention. Any changes or adjustments to their relative order, without substantive changes to the technical content, are also considered within the scope of the present invention's implementation.

When an embodiment provides a numerical range, it should be understood that, unless otherwise specified in the present invention, both endpoints of the numerical range and any value between the two endpoints are selectable. Unless otherwise defined, all technical and scientific terms used in the present invention have the same meaning as commonly understood by those skilled in the art. In addition to the specific methods, devices, and materials used in the embodiments, any similar or equivalent methods, devices, and materials of the existing technology can be used to implement the present invention based on the knowledge of one of ordinary skill in the art and the descriptions of the present invention.

A method for synthesizing polyphenylene ether is provided in an embodiment of the present invention, in which polymerization monomers and oxygen are subjected to a condensation reaction under the action of a catalyst to form polyphenylene ether, and the molecular weight and molecular weight distribution of polyphenylene ether can be regulated by controlling the addition rate and amount of the catalyst during the reaction process.

In a preferred embodiment, the condensation reaction is carried out in a polymerizer.

In a preferred embodiment, the reactor is purged with nitrogen before the reaction, reducing the oxygen content to below 2%.

In a preferred embodiment, the polymer monomer is a phenolic compound.

In a preferred embodiment, the polymer monomer is selected from 2,6-dimethylphenol, 2,6-diethylphenol, 2-ethyl-6-n-propylphenol, 2-ethyl-6-bromophenol, and 2-methyl-6-n-butylphenol.

In a preferred embodiment, the polymer monomer is 2,6-dimethylphenol.

In a preferred embodiment, the condensation reaction utilizes a good solvent and a poor solvent.

In a preferred embodiment, the poor solvent is selected from alcohols (such as methanol, ethanol, propanol, butanol, benzyl alcohol, cyclohexanol), ketones (such as acetone, methyl ethyl ketone), esters (such as ethyl acetate, ethyl formate), and ethers (such as tetrahydrofuran, ether, diethyl ether).

In a preferred embodiment, the poor solvent is methanol.

In a preferred embodiment, the good solvent is selected from aromatic hydrocarbons (such as benzene, toluene, ethylbenzene, xylene) and halogenated hydrocarbons (such as chloroform, dichloroethane, trichloroethane, chlorobenzene).

In a preferred embodiment, the good solvent is toluene.

In a preferred embodiment, the mass ratio of the poor solvent to the good solvent is greater than 1.

In a preferred embodiment, the mass ratio of the poor solvent to the good solvent is (1˜1.5):1.

In a preferred embodiment, the condensation reaction is conducted under stirring and external circulation conditions.

In a preferred embodiment, the catalyst is one or more of cuprous compounds (such as cuprous chloride, cuprous bromide, cuprous nitrate, cuprous sulfate), copper compounds (such as copper chloride, copper bromide, copper nitrate, copper sulfate), and copper salts (such as those obtained by reacting copper oxide or cuprous oxide with hydrohalic acid).

In a preferred embodiment, the catalyst is one or more of cuprous chloride, cuprous bromide, copper chloride, and copper bromide.

In a preferred embodiment, the condensation reaction also employs a copper ion protector.

In a preferred embodiment, the copper ion protector is one or more of secondary alkylene diamines, tertiary amines, and monoamines.

In a preferred embodiment, the copper ion protector is one or more of dimethylamine, diethylamine, piperazine, morpholine, and methylmorpholine.

In a preferred embodiment, the copper ion protector is one or more of N,N-di-tert-butylethylenediamine and N,N-diisopropylethylenediamine.

In a preferred embodiment, the copper ion protector is one or more of trimethylamine, triethylamine, tripropylamine, tributylamine, diethylmethylamine, dimethylpropylamine, and dimethyl-n-butylamine.

In a preferred embodiment, the catalyst and protector are formed into a solution containing the catalyst and protector.

In a preferred embodiment, the polymer monomer is formed into a solution containing the good solvent and the polymer monomer.

In a preferred embodiment, the solution containing the catalyst and protector and the solution containing the good solvent solution and the polymer monomer are respectively added to the reaction medium containing the good solvent and the poor solvent.

In a preferred embodiment, the polymer monomer is added dropwise to the reaction system.

In a preferred embodiment, the total dropwise addition time for each kilogram of the polymer monomer is 4˜8 min, such as 4 min, 4.5 min, 5 min, 5.5 min, 6 min, 6.5 min, 7 min, 7.5 min, or 8 min.

In a preferred embodiment, while adding the polymer monomer dropwise, oxygen is introduced, and nitrogen (for purge) is also introduced from the top of the reaction vessel to maintain the oxygen concentration in the reaction system below 20%. In a preferred embodiment, the concentration of oxygen in the reaction system is less than 10%.

In a preferred embodiment, the ratio of the oxygen introduction rate to the nitrogen introduction rate is 1:(5˜20).

In a preferred embodiment, the ratio of the oxygen introduction rate to the nitrogen introduction rate is 1:10.

In a preferred embodiment, per unit time, the molar ratio of the added oxygen to the added polymer monomer is 0.5˜1.5, such as 0.5˜0.8, 0.8˜1.0, 1.0˜1.2, or 1.2˜1.5.

In a preferred embodiment, per unit time, the molar ratio of the introduced oxygen to that of the added polymer monomer is 0.8˜1.0.

In a preferred embodiment, the catalyst is added at a rate that is slow at first and then fast. In the present invention, through extensive tests, the inventors have found that adding the catalyst at a slow first and then fast rate avoids a high catalyst concentration in the system during the initial reaction stage, and a high catalyst concentration will lead to the generation of a large amount of oligomers. Adding the catalyst in this manner is conducive to increasing the molecular weight while narrowing the molecular weight distribution.

In a preferred embodiment, the total addition time of the catalyst is 0.5˜1.0 times the addition time of the polymer monomer, such as 0.5˜0.7 times, 0.7˜0.9 times, or 0.9˜1.0 times.

In a preferred embodiment, starting from the time when oxygen is introduced, the time of the condensation reaction is 60˜90 min, such as 60˜65 min, 65˜70 min, 70˜75 min, 75˜80 min, 80˜85 min, or 85˜90 min.

In a preferred embodiment, the pressure of the condensation reaction is normal pressure.

In a preferred embodiment, the temperature of the condensation reaction is 20˜50° C.

In a preferred embodiment, the temperature of the condensation reaction is 20˜35° C.

In a preferred embodiment, the temperature of the condensation reaction gradually increases as the reaction progresses.

In a preferred embodiment, the temperature is maintained at 20˜25° C. during the addition of the polymer monomer.

In a preferred embodiment, the temperature is maintained at 20° C. during the addition of the polymer monomer.

In a preferred embodiment, after the addition of the polymer monomer is completed, the temperature is gradually raised to 30˜50° C. and maintained at 30˜50° C. until the end of the reaction.

In a preferred embodiment, after the addition of the polymer monomer is completed, the temperature is gradually raised to 30° C. and maintained at 30° C. until the end of the reaction.

In a preferred embodiment, for 1 mol of the polymer monomer, the copper ion content in the synthesis reaction is 0.001˜0.3 mol.

In a preferred embodiment, for 1 mol of the copper ion, the amount of copper ion protector in the synthesis reaction is 0.01˜60 mol.

In a preferred embodiment, for 1 mol of the copper ion, the amount of copper ion protector in the synthesis reaction is 0.05˜5 mol.

In a preferred embodiment, for 1 mol of the copper ion, the amount of copper ion protector in the synthesis reaction is 0.01˜4 mol.

In a preferred embodiment, a suspension containing polyphenylene ether particles is obtained through the condensation reaction and the suspension undergoes a first copper removal treatment.

In a preferred embodiment, the first copper removal treatment involves contacting the suspension with an aqueous solution of amino carboxylic acid derivatives to remove copper through complexation.

In a preferred embodiment, the amino carboxylic acid derivative is one or more of ethylenediaminetetraacetic acid or a salt thereof, iminodiacetic acid or a salt thereof, ethylenediaminetetrapropionic acid or a salt thereof, and nitrilotriacetic acid or a salt thereof.

In a preferred embodiment, the amino carboxylic acid derivative is ethylenediaminetetraacetic acid and its di-, tri-, and tetra-sodium or potassium salts.

In a preferred embodiment, the molar ratio of the amino carboxylic acid derivative to the copper ion is (1˜3):1.

In a preferred embodiment, the molar ratio of the amino carboxylic acid derivative to the copper ion is 1:1.

In a preferred embodiment, the temperature of the first copper removal treatment is 45˜50° C.

In a preferred embodiment, the time of the first copper removal treatment is 0.2˜1 h, such as 0.2˜0.3 h, 0.3˜0.4 h, 0.4˜0.5 h, 0.5˜0.6 h, 0.7˜0.8 h, 0.8˜0.9 h, or 0.9˜1.0 h.

In a preferred embodiment, the synthesis method also includes separating the solid-liquid system after the first copper removal treatment to obtain the first polyphenylene ether filter cake and liquid phase components.

In a preferred embodiment, the copper ion content in the first polyphenylene ether filter cake obtained after the first copper removal treatment is 10˜100 ppm.

In a preferred embodiment, the synthesis method includes performing a second copper removal treatment on a homogeneous solution of the first polyphenylene ether filter cake using an aqueous solution of a complexing agent.

In a preferred embodiment, the complexing agent is one or more of sodium gluconate, ethylenediaminetetraacetic acid or a salt thereof, iminodiacetic acid or a salt thereof, ethylenediaminetetrapropionic acid or a salt thereof, and nitrilotriacetic acid or a salt thereof.

In a preferred embodiment, the pH of the aqueous solution of the complexing agent is at least 5, such as 5, 5.5, 6, 6.5, 7, 7.5, 8, 8.5, 9, 9.5, 10, 10.5, 11, 11.5, 12, 12.5, 13, or 13.5.

In a preferred embodiment, the complexing agent is an aqueous solution of sodium gluconate.

In a preferred embodiment, the complexing agent is an aqueous solution of sodium gluconate with a pH of 11.

In a preferred embodiment, the homogeneous solution of the first polyphenylene ether filter cake is formed by dissolving the first polyphenylene ether filter cake in the good solvent.

In a preferred embodiment, the concentration of polyphenylene ether in the homogeneous solution of the first polyphenylene ether filter cake is 15˜30 wt %.

In a preferred embodiment, the concentration of polyphenylene ether in the homogeneous solution of the first polyphenylene ether filter cake is 20˜25 wt %.

In a preferred embodiment, the second copper removal treatment involves adding the aqueous solution of sodium gluconate with a pH of 11 to the homogeneous solution of the first polyphenylene ether filter cake to form a mixed solution.

In a preferred embodiment, the molar ratio of sodium gluconate in the mixed solution to the copper ions in the homogeneous solution of the first polyphenylene ether filter cake is (1˜10):1, such as 1:1, 2:1, 3:1, 4:1, 5:1, 6:1, 7:1, 8:1, 9:1, or 10:1.

In a preferred embodiment, in the mixed solution, the mass of the aqueous solution of sodium gluconate is 0.01˜0.5 times the mass of the homogeneous solution of the first polyphenylene ether filter cake.

In a preferred embodiment, in the mixed solution, the mass of the aqueous solution of sodium gluconate is 0.1˜0.3 times the mass of the homogeneous solution of the first polyphenylene ether filter cake.

In a preferred embodiment, the synthesis method includes obtaining a homogeneous polyphenylene ether solution after the second copper removal treatment through oil-water phase separation.

In a preferred embodiment, stirring is performed before the oil-water phase separation.

In a preferred embodiment, the stirring time before the oil-water phase separation is 15˜30 min.

In a preferred embodiment, the stirring temperature before the oil-water phase separation is 45˜50° C.

In a preferred embodiment, the oil-water phase separation is centrifugation or standing phase separation.

In a preferred embodiment, the synthesis method includes obtaining solid polyphenylene ether through post-treatment.

In a preferred embodiment, the post-treatment includes one or more of precipitation, filtration, washing, and drying.

In a preferred embodiment, the precipitation includes adding the poor solvent and water to the homogeneous polyphenylene ether solution after the second copper removal treatment, causing the polyphenylene ether to precipitate, thereby obtaining a polyphenylene ether suspension.

In a preferred embodiment, the mass of the poor solvent added during the precipitation is 1.5˜2 times the mass of the good solvent in the polyphenylene ether solution.

In a preferred embodiment, the mass of water added during the precipitation is 0.01˜0.1 times the mass of the poor solvent.

In a preferred embodiment, the filtration includes filtering the polyphenylene ether suspension to obtain a second polyphenylene ether filter cake.

In a preferred embodiment, the washing includes rinsing the second polyphenylene ether filter cake using the poor solvent to wash away most of the good solvent in the filter cake.

In a preferred embodiment, the drying includes drying the washed second polyphenylene ether filter cake to further remove the solvent.

An embodiment of the present invention provides a polyphenylene ether with a Mn of 30,000˜60,000, a molecular weight distribution of less than 1.8, and a copper residue of less than 0.05 ppm.

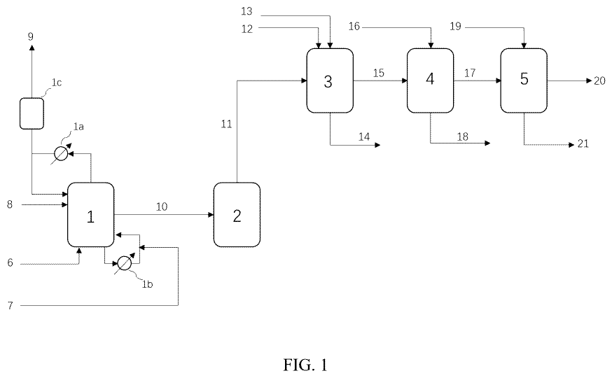

As shown in the specific embodiment in FIG. 1, the reaction includes the following steps and parameters:

1) The polymerization monomers, oxygen, and catalyst solution are subjected to a condensation reaction in a polymerizer 1 containing a good solvent and a bad solvent to obtain a reaction material, wherein the condensation reaction comprises one or more of the following:
before the reaction begins, nitrogen is introduced into the polymerizer 1 for purging through a material pipeline 8 for gas replacement, reducing the oxygen content in the reactor to below 2%;
the poor solvent and good solvent are added to the polymerizer 1, and the mass ratio of the poor solvent to the good solvent is greater than 1;
an external circulation heat exchanger 1b of the polymerizer 1 is provided to remove reaction heat and enhance stirring;
the catalyst and a copper ion protector are dissolved to form a solution containing the catalyst and copper ion protector;
for 1 mol of the polymer monomers, the copper ion content in the condensation reaction is 0.001˜0.3 mol; because reducing the catalyst amount lowers product yield, while increasing the catalyst amount decreases average molecular weight and increases molecular weight distribution, an appropriate amount of catalyst is used in the present invention to ensure both product yield and the desired average molecular weight and molecular weight distribution;
for 1 mol of copper ion, the amount of the copper ion protector in the condensation reaction is 0.01˜60 mol;
the polymer monomers are added dropwise to the polymerizer 1 through a material pipeline 7, in the present invention, the polymer monomers are added continuously at an interval, rather than all at once;
the catalyst is added to the polymerizer 1 at a rate that is slow at first and then fast;
the catalyst is also added dropwise, continuously at an interval, with a varying rate that changes from slow to fast;
oxygen is introduced into the bottom of the polymerizer 1 through a material pipeline 6 during the dropwise addition of the polymer monomers;
the temperature of the condensation reaction is 20˜35° C., starting at a low temperature, slowly and uniformly increasing to the maximum temperature over 10˜50 min after the reaction begins, and maintaining this maximum temperature until the reaction ends;
nitrogen is continuously introduced to the top of the polymerizer 1 through a material pipeline 8, maintaining the oxygen content in the upper part of the polymerizer below 10%;
under the same reaction conditions, a longer total dropwise addition time for the polymer monomers helps increase the molecular weight of polyphenylene ether but is not conducive to reducing the molecular weight distribution, therefore, the total dropwise addition time for the polymer monomers in the present invention is 45˜60 min when taking the target molecular weight, molecular weight distribution, yield, and cost into consideration;
the total addition time of the catalyst is 0.5˜1.0 times the addition time of the polymer monomers;
starting from the time when oxygen is introduced, the time of the condensation reaction is 60˜90 min;
the oxygen addition molar rate is 0.5˜1.5 times the addition molar rate of the polymer monomers;
unreacted oxygen and nitrogen, along with the liquid phase in the polymerizer 1, pass through a condenser 1a and are separated into gas and liquid phases in a gas-liquid separation tank 1c, with the gas phase components being discharged through a material pipeline 9;
an aqueous solution of amino carboxylic acid derivatives is added to the polymerizer 1 to contact the polyphenylene ether suspension obtained after the reaction for a first copper removal treatment.
the molar ratio of the amino carboxylic acid derivative to the copper ions in the polyphenylene ether suspension is (1˜3):1;
the temperature for the first copper removal treatment is 45˜50° C., with a duration of 0.2˜1 h.

2) A slurry after the first copper removal treatment is discharged from the polymerizer 1 through a material pipeline 10 into filtration equipment 2, wherein a filtration is performed in the filtration equipment 2 to obtain a first polyphenylene ether filter cake.

The copper ion content in the first polyphenylene ether filter cake obtained after the first copper removal treatment is 10˜100 ppm.

3) The first polyphenylene ether filter cake is transported to a dissolving reactor 3 through a material pipeline 11. The good solvent is added to the dissolving reactor 3 through a material pipeline 12 to prepare a homogeneous solution of polyphenylene ether.

The concentration of polyphenylene ether in the homogeneous solution is 20˜25 wt %.

An aqueous solution of sodium gluconate is added to the dissolving reactor 3 through a material pipeline 13 for a second copper removal treatment, resulting in a mixed solution. In the present invention, the first polyphenylene ether filter cake is redissolved, and sodium gluconate aqueous solution is used for chelation, followed by filtration and washing to effectively reduce the residual copper content in the polyphenylene ether product.

The molar ratio of sodium gluconate in the mixed solution to copper ions in the homogeneous solution of the first polyphenylene ether filter cake is (2˜10):1.

The mass of aqueous solution in the mixed solution is 0.1˜0.3 times the mass of the polyphenylene ether solution.

The mixed solution is stirred at 45˜50° C. for 15˜30 minutes.

The mixed solution is subjected to oil-water phase separation to obtain a homogeneous polyphenylene ether solution after the second copper removal treatment.

4) The upper oil phase is transported to a precipitation filtration reactor 4 through a material pipeline 15, and the lower water phase is transported to the subsequent unit through a material pipeline 14.

A poor solvent and water are added to the precipitation filtration reactor 4 through a material pipeline 16 to precipitate the polyphenylene ether.

The mass of the poor solvent added is 1.5˜2 times the mass of the good solvent in the polyphenylene ether solution.

The mass of water added is 0.01˜0.1 times the mass of the poor solvent.

The obtained non-homogeneous solution in the precipitation filtration reactor 4 is filtered to provide a second polyphenylene ether filter cake.

5) The second polyphenylene ether filter cake is transported to a washing filtration reactor 5 through a material pipeline 17. A poor solvent is added to the washing filtration reactor 5 through a material pipeline 19 to wash the second polyphenylene ether filter cake.

6) The washed second polyphenylene ether filter cake is filtered and transported to the drying unit through a material pipeline 20. The liquid phase components after washing and filtration are transported to the post-treatment unit through a material pipeline 30.

The product polyphenylene ether has a Mn of 30,000˜60,000, a molecular weight distribution of less than 1.8, and a copper residue of less than 0.05 ppm.

In the examples and comparative examples of the present invention, the molecular weight of polyphenylene ether is determined using the corrected curve measured by gel permeation chromatography (GPC), with Shodex HFIP-806M columns and an RI detector. The specific steps are as follows: an appropriate amount of polyphenylene ether sample is dissolved in toluene to prepare a 1 mg/mL solution; the measurement temperature is set to 38° C., the mobile phase is tetrahydrofuran, and the flow rate is set to 1 mL/min. The measured results are compared with the monodisperse polystyrene (PS) standard samples to determine the molecular weight of the obtained polyphenylene ether.

In the examples and comparative examples of the present invention, the copper content in polyphenylene ether is detected by ICP-MS: the polyphenylene ether polymer is crushed using a ball mill, mixed with aqua regia, subjected to microwave acidolysis, diluted to a constant volume, and quantitatively analyzed using the 7700 series ICP-MS system (G3281A).

### Example 1

The experimental setup shown in FIG. 1 is employed.

A 100-liter polymerizer was purged with nitrogen to reduce the oxygen content to below 2%. Then, 22 kilograms of toluene and 23.1 kilograms of methanol were added. The stirring and external circulation of the polymerizer were started, with the external circulation powered by a slurry pump at a circulation rate of 1000 liters per hour.

The catalyst and protector solution was prepared; specifically, 200 g of water, 52.9 g (0.37 mol) of cuprous bromide, 13 g (0.076 mol) of N,N-di-tert-butylethylenediamine, 75 g (0.74 mol) of dimethylbutylamine, and 32 g (0.37 mol) of morpholine were added together and mixed by stirring.

The temperature inside the polymerizer was adjusted to 20° C. using the polymerizer's temperature control device. Then, 9020 g of 2,6-dimethylphenol was added dropwise over 50 minutes. Ten minutes after the addition of the monomers, the catalyst solution was added dropwise over 30 minutes (40 g was added in the first 10 min, 80 g was added in the next 10 min, and 132.9 g was added in the last 10 min).

Oxygen was introduced from the bottom of the polymerizer at a flow rate of 25 liters per minute simultaneously with the start of monomer addition. After polymerization began, the reaction temperature was maintained at 20° C. in the initial 10 minutes, and was slowly and uniformly increased to 35° C. over the period from the 10th to 50th minute after the reaction started, then held constant. Nitrogen was continuously introduced from the top of the polymerizer at a rate of 300 liters per minute to keep the oxygen concentration in the gas phase space of the polymerizer below 10%. Oxygen introduction was stopped after 90 minutes. A 2% disodium ethylenediaminetetraacetate (EDTA) solution (containing 0.74 mol of disodium EDTA) was added in an amount of 12.4 kilograms, and the temperature was raised to 45° C. Stirring and external circulation were maintained for 1 hour for the first copper removal treatment. After standing and filtering, a first polyphenylene ether filter cake was obtained, with a copper residue of 14 ppm.

The first filter cake was redissolved using 34.5 kilograms of toluene for the second copper removal treatment, the polymerizer was heated to 60° C., and the mixture was stirred for 1 hour. 21 kilograms of an aqueous sodium gluconate solution (pH 11) was added to the polyphenylene ether solution, with a molar ratio of sodium gluconate to residual copper of 3:1. After stirring at 45° C. for 30 minutes, the lower aqueous phase was separated by filtration, and 69 kilograms of methanol and 6 kilograms of water were added to the upper toluene phase. After stirring to precipitate the polyphenylene ether, filtration was performed. The obtained second polyphenylene ether filter cake was washed with 5 kilograms of methanol, and then the second filter cake was dried. The collected polyphenylene ether product had a copper content of 0.035 ppm, a molecular weight distribution of 1.38, and an average molecular weight of 43478.

### Comparative Example 1

The experimental setup shown in FIG. 1 is employed.

Compared to Example 1, only the first copper removal treatment is performed.

The second copper removal treatment and subsequent steps in Example 1 were omitted, the remaining steps in Comparative Example 1 were the same as in Example 1. The non-homogeneous phase solution after the first copper removal treatment was allowed to stand and then filtered to obtain a polyphenylene ether filter cake. Additionally, the polyphenylene ether filter cake was washed three times with 30 kilograms of fresh methanol, and then filtered and dried. The collected polyphenylene ether product had a copper content of 8.2 ppm, a molecular weight distribution of 1.38, and an average molecular weight of 43513.

### Comparative Example 2

The experimental setup shown in FIG. 1 is employed.

Compared to Example 1, a different complexing agent is used in the second copper removal treatment.

The sodium gluconate aqueous solution added during the second copper removal treatment in Example 1 was replaced with 21 kilograms of an EDTA sodium salt aqueous solution, with a molar ratio of EDTA sodium salt to residual copper of 3:1. The remaining steps in Comparative Example 2 were the same as in Example 1. The collected polyphenylene ether product had a copper content of 0.52 ppm, a molecular weight distribution of 1.39, and an average molecular weight of 43501.

### Comparative Example 3

The experimental setup shown in FIG. 1 is employed.

Compared to Example 1, no optimization is performed in the addition manners of the polymer monomers and catalyst, as well as in the temperature control.

The polymer monomers and catalyst were all added to the polymerizer before heating, then the temperature was raised to 35° C. Oxygen was then introduced, starting the reaction. The remaining steps in Comparative Example 3 were the same as in Example 1. The collected polyphenylene ether product had a copper content of 0.038 ppm, a molecular weight distribution of 2.82, and an average molecular weight of 24718.

### Comparative Example 4

The experimental setup shown in FIG. 1 is employed.

Compared to Example 1, no optimization is performed in the addition manner of the catalyst and in the temperature control.

The catalyst was all added to the polymerizer before heating, then the temperature was raised to 35° C. The polymer monomers were added dropwise, and oxygen was introduced at the same time, marking the start of the reaction. The remaining steps in Comparative Example 4 were the same as in Example 1. The collected polyphenylene ether product had a copper content of 0.037 ppm, a molecular weight distribution of 2.25, and an average molecular weight of 30786.

### Comparative Example 5

The experimental setup shown in FIG. 1 is employed.

Compared to Example 1, no optimization is performed in the addition manner of the catalyst.

The catalyst was all added to the polymerizer before heating, and the remaining steps in Comparative Example 5 were the same as in Example 1. The collected polyphenylene ether product had a copper content of 0.035 ppm, a molecular weight distribution of 1.78, and an average molecular weight of 37874.

### Comparative Example 6

The experimental setup shown in FIG. 1 is employed.

Compared to Example 1, the addition rate of the polymerized monomers is slowed down thereby extending the reaction time.

The dropwise addition time of the polymerized monomers in Example 1 was extended from 50 min to 60 min, and the remaining steps in Comparative Example 6 were the same as in Example 1. The collected polyphenylene ether product had a copper content of 0.031 ppm, a molecular weight distribution of 1.47, and an average molecular weight of 45183.

### Comparative Example 7

The experimental setup shown in FIG. 1 is employed.

Compared to Example 1, the addition rate of the polymerized monomers is slowed down thereby extending the reaction time.

The dropwise addition time of the polymerized monomers in Example 1 was extended from 50 min to 120 min, and the remaining steps in Comparative Example 7 were the same as in Example 1. The collected polyphenylene ether product had a copper content of 0.033 ppm, a molecular weight distribution of 2.11, and an average molecular weight of 46762.

### Comparative Example 8

The experimental setup shown in FIG. 1 is employed.

Compared to Example 1, the reaction temperature is changed.

The reaction temperature was kept at 20° C. for the whole reaction, and the remaining steps in Comparative Example 8 were the same as in Example 1. The collected polyphenylene ether product had a copper content of 0.037 ppm, a molecular weight distribution of 1.35, and an average molecular weight of 41359.

### Comparative Example 9

The experimental setup shown in FIG. 1 is employed.

Compared to Example 1, the reaction temperature is changed.

The initial reaction temperature was maintained at 20° C., and during the reaction, the temperature was uniformly increased to 40° C. and then held constant. The remaining steps in Comparative Example 9 were the same as in Example 1. The collected polyphenylene ether product had a copper content of 0.036 ppm, a molecular weight distribution of 1.41, and an average molecular weight of 43653.

### Comparative Example 10

The experimental setup shown in FIG. 1 is employed.

Compared to Example 1, the reaction temperature is changed.

The initial reaction temperature was maintained at 20° C., and during the reaction, the temperature was uniformly increased to 50° C. and then held constant. The remaining steps in Comparative Example 10 were the same as in Example 1. The collected polyphenylene ether product had a copper content of 0.036 ppm, a molecular weight distribution of 1.85, and an average molecular weight of 43857.

### Comparative Example 11

The experimental setup shown in FIG. 1 is employed.

Compared to Example 1, the total amount of the catalyst is changed.

The amount of the catalyst was reduced from 0.05 eq (in Example 1) to 0.01 eq, and the remaining steps in Comparative Example 11 were the same as in Example 1. The collected polyphenylene ether product had a copper content of 0.027 ppm, a molecular weight distribution of 1.31, and an average molecular weight of 43380.

### Comparative Example 12

The experimental setup shown in FIG. 1 is employed.

Compared to Example 1, the total amount of the catalyst is changed.

The amount of the catalyst was increased from 0.05 eq (in Example 1) to 0.1 eq, and the remaining steps in Comparative Example 12 were the same as in Example 1. The collected polyphenylene ether product had a copper content of 0.039 ppm, a molecular weight distribution of 1.42, and an average molecular weight of 41704.

### Comparative Example 13

The experimental setup shown in FIG. 1 is employed.

Compared to Example 1, the total amount of the catalyst is changed.

The amount of the catalyst was increased from 0.05 eq (in Example 1) to 0.3 eq, and the remaining steps in Comparative Example 13 were the same as in Example 1. The collected polyphenylene ether product had a copper content of 0.048 ppm, a molecular weight distribution of 1.51, and an average molecular weight of 38128.

### Summary of Examples and Comparative Examples

The average molecular weight, molecular weight distribution, and copper residue results of the products prepared from Example 1 and Comparative examples 1 to 13 are shown in Table 1 below.

TABLE 1
Reaction conditions, molecular weight distribution, and copper
residue results of Example 1 and Comparative Examples 1~13

| | | | | | Average | Molecular | |
|---|---|---|---|---|---|---|---|
| Serial | Reaction | Reaction | Catalyst | | molecular | weight | Copper |
| number | time/min | temperature/° C. | usage/eq | Yield/% | weight | distribution | residue/ppm |
| Example 1 | 50 | 20~35 | 0.05 | 96.5 | 43478 | 1.38 | 0.035 |
| Comparative | 50 | 20~35 | 0.05 | 95.1 | 43513 | 1.38 | 8.2 |
| Example 1 | | | | | | | |
| Comparative | 50 | 20~35 | 0.05 | 96.6 | 43501 | 1.39 | 0.52 |
| Example 2 | | | | | | | |
| Comparative | 50 | 35 | 0.05 | 96.7 | 24718 | 2.82 | 0.038 |
| Example 3 | | | | | | | |
| Comparative | 50 | 35 | 0.05 | 96.9 | 30786 | 2.25 | 0.037 |
| Example 4 | | | | | | | |
| Comparative | 50 | 20~35 | 0.05 | 96.1 | 37874 | 1.78 | 0.035 |
| Example 5 | | | | | | | |
| Comparative | 60 | 20~35 | 0.05 | 97.1 | 45183 | 1.47 | 0.031 |
| Example 6 | | | | | | | |
| Comparative | 120 | 20~35 | 0.05 | 98.5 | 46762 | 2.11 | 0.033 |
| Example 7 | | | | | | | |
| Comparative | 50 | 20 | 0.05 | 83.2 | 41359 | 1.35 | 0.037 |
| Example 8 | | | | | | | |
| Comparative | 50 | 20~40 | 0.05 | 96.4 | 43653 | 1.41 | 0.036 |
| Example 9 | | | | | | | |
| Comparative | 50 | 20~50 | 0.05 | 97.1 | 43857 | 1.85 | 0.036 |
| Example 10 | | | | | | | |
| Comparative | 50 | 20~35 | 0.01 | 92.2 | 43380 | 1.31 | 0.027 |
| Example 11 | | | | | | | |
| Comparative | 50 | 20~35 | 0.1 | 96.7 | 41704 | 1.42 | 0.039 |
| Example 12 | | | | | | | |
| Comparative | 50 | 20~35 | 0.3 | 97.0 | 38128 | 1.51 | 0.048 |
| Example 13 | | | | | | | |

Based on the experimental results in Table 1, the following conclusions can be drawn.

### 1. Selection of the Complexing Agent in the Second Copper Removal Treatment

From Example 1 and Comparative Examples 1-2, it can be seen that according to the process route of the present invention, redissolving the first polyphenylene ether filter cake, using a sodium gluconate aqueous solution for chelation, followed by filtration and washing, can effectively reduce the residual copper content in the polyphenylene ether product. Simply using methanol as a poor solvent to wash the filter cake obtained from filtering the polymerizer does not effectively remove the residual copper. Using EDTA as a reagent for second copper removal treatment has limited effectiveness.

### 2. Addition Manners of the Polymer Monomers and Catalyst, and Temperature Control

From Example 1 and Comparative Examples 3-5, it can be seen that according to the process route of the present invention, changing the addition manners of the polymer monomers and the catalyst, and reasonably controlling the temperature have a significant effect on increasing the average molecular weight of the polyphenylene ether product and narrowing its molecular weight distribution. Changing the addition manner of the catalyst has the most noticeable effect.

### 3. Reaction Temperature and Reaction Time

From Example 1 and Comparative Examples 6-10, it can be seen that raising the reaction temperature has little effect on the average molecular weight of the product but significantly widens the molecular weight distribution. Prolonging the reaction time can significantly increase the average molecular weight but also significantly widen the molecular weight distribution.

### 4. The Amount of the Catalyst Added

From Example 1 and Comparative Examples 11-13, it can be seen that reducing the amount of the catalyst decreases the residual copper content in the product but also significantly reduces the product yield. Increasing the amount of catalyst can reduce the average molecular weight to some extent and widen the molecular weight distribution. Additionally, the second copper removal treatment in the process route of the present invention can still achieve a low residual copper content in the product, even with a significant increase in copper usage, effectively removing copper from the final product. The residual copper contents in all products are below 50 ppb.

The foregoing embodiments are only illustrative of the principles and efficacy of the present invention and are not intended to limit the present invention. Any person skilled in the art may modify or change the above embodiments without violating the spirit and scope of the present invention. Accordingly, all equivalent modifications or alterations accomplished by persons having ordinary knowledge of the art without departing from the spirit and technical ideas disclosed herein shall still be covered by the claims of the present invention.

1. A method for synthesizing polyphenylene ether, comprising: conducting a condensation reaction of a polymer monomer and oxygen under an action of a catalyst to form polyphenylene ether; wherein a molecular weight and molecular weight distribution of polyphenylene ether are regulated by controlling an addition rate and an amount of the catalyst during the condensation reaction process.

2. The method according to claim 1, wherein the polymer monomer is a phenolic compound, and the phenolic compound comprises 2,6-dimethylphenol, 2,6-diethylphenol, 2-ethyl-6-n-propylphenol, 2-ethyl-6-bromophenol, and 2-methyl-6-n-butylphenol.

3. The method according to claim 1, wherein the condensation reaction further employs a good solvent and a poor solvent; wherein the poor solvent is selected from alcohols, ketones, esters, and ethers, and the good solvent is selected from aromatic hydrocarbons and halogenated hydrocarbons.

4. The method according to claim 1, wherein the catalyst comprises one or more of cuprous compounds, copper compounds, and copper salts; and/or
wherein the condensation reaction further employs a copper ion protector, wherein the copper ion protector comprises one or more of secondary alkylene diamines, tertiary amines, and monoamines.

5. The method according to claim 2, further comprising: forming a first solution containing the catalyst and a copper ion protector, forming a second solution containing a good solvent and the polymer monomer, and adding the first solution containing the catalyst and the copper ion protector and the second solution containing the good solvent and the polymer monomer to a reaction medium containing the good solvent and a poor solvent.

6. The method according to claim 1, further comprising: adding the polymer monomer to a reaction system dropwise, with a total dropwise addition time of 4˜8 min per kilogram of the polymer monomer.

7. The method according to claim 6, further comprising: introducing oxygen to a bottom of a reaction vessel while the polymer monomer is added dropwise, and introducing nitrogen to a top of the reaction vessel to keep an oxygen concentration in the reaction system below 20%;
and/or, wherein per unit of time, a molar ratio of introduced oxygen to that of added polymer monomer is 0.5˜1.5.

8. The method according to claim 4, further comprising: adding the catalyst at a rate that is slow at first and then fast;
and/or, wherein a total addition time of the catalyst is 0.5˜1.0 times an addition time of the polymer monomer.

9. The method according to claim 7, wherein starting from the time when oxygen is introduced, a duration of the condensation reaction is 60˜90 min.

10. The method according to claim 1, wherein a temperature of the condensation reaction is 20˜50° C., wherein the temperature is maintained at 20-25° C. during the addition of the polymer monomer, and after the addition of the polymer monomer is completed, the temperature is gradually increased to 30-50° C. and maintained at 30-50° C. until the end of reaction.

11. The method according to claim 4, wherein for 1 mol of the polymer monomer, a content of copper ions in a reaction system is 0.001˜0.3 mol;
and/or, wherein for 1 mol of the copper ions, an amount of copper ion protector in the reaction system is 0.01˜60 mol.

12. The method according to claim 1, further comprising: obtaining a suspension containing polyphenylene ether particles after the condensation reaction; and performing a first copper removal treatment on the suspension, wherein the first copper removal treatment comprises contacting an amino carboxylic acid derivative aqueous solution with the suspension to remove copper through complexation.

13. The method according to claim 12, wherein the amino carboxylic acid derivative comprises one or more of ethylenediaminetetraacetic acid or a salt thereof, iminodiacetic acid or a salt thereof, ethylenediaminetetrapropionic acid or a salt thereof, and nitrilotriacetic acid or a salt thereof.

14. The method according to claim 12, wherein a molar ratio of an amount of the amino carboxylic acid derivative to copper ions is (1˜3):1.

15. The method according to claim 12, further comprising: performing a solid-liquid separation on a system obtained after the first copper removal treatment, to obtain a polyphenylene ether filter cake and liquid phase components.

16. The method according to claim 15, wherein a content of copper ions in the polyphenylene ether filter cake is 10˜100 ppm;
and/or, wherein a second copper removal treatment is performed on a homogeneous solution of the polyphenylene ether filter cake using an aqueous solution of a complexing agent.

17. The method according to claim 16, wherein the complexing agent is one or more of sodium gluconate, ethylenediaminetetraacetic acid or a salt thereof, iminodiacetic acid or a salt thereof, ethylenediaminetetrapropionic acid or a salt thereof, and nitrilotriacetic acid or a salt thereof;
and/or, wherein a pH of the aqueous solution of the complexing agent is at least 5.

18. The method according to claim 16, wherein the homogeneous solution of the polyphenylene ether filter cake is formed by dissolving the polyphenylene ether filter cake in a good solvent;
and/or, wherein an oil-water phase separation is performed after the second copper removal treatment to obtain a homogeneous solution of the polyphenylene ether.

19. The method according to claim 18, further comprising: stirring the homogeneous solution of the polyphenylene ether filter cake at a temperature of 40˜50° C. for 15˜30 min before the oil-water phase separation;
wherein a solid polyphenylene ether is obtained after a post-treatment, and wherein the post-treatment comprises one or more of precipitation, filtration, and washing.

20. The method according to claim 1, wherein the polyphenylene ether has a Mn of 30,000˜60,000, a molecular weight distribution of less than 1.8, and a copper residue of less than 0.05 ppm.
